(19) United States
(12) Patent Application Publication
(10) Pub. No.: US 2007/0288923 A1
(43) Pub. Date: Dec. 13, 2007

(54) WORK ASSISTING APPARATUS, METHOD, AND PROGRAM

(75) Inventors: Takeichiro Nishikawa, Yokohama-Shi (JP); Kentaro Torii, Yokohama-Shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/689,778

(22) Filed: Mar. 22, 2007

(30) Foreign Application Priority Data
Jun. 13, 2006 (JP) 2006-163451

(51) Int. Cl. G06F 9/46

(52) U.S. Cl. 718/100

(57) ABSTRACT

According to an aspect of the present invention, there is provided with a work assisting method, including: providing an information storage which stores a plurality of process maps that define constraint on order of carrying out tasks in a work process, task check information that represent check items for the tasks in each process map, and task time information that represent required times for the tasks in each process map; inputting execution instruction information that instructs execution of a work; detecting a process map that matches to a work indicated in the execution instruction information; collecting check information that is necessary for checking check items associated with tasks in detected process map; checking the check items to detect a task error; and notifying information that represents content of detected task error.

### CROSS-REFERENCE TO RELATED APPLICATIONS

This application is based upon and claims the benefit of priority from the prior Japanese Patent Applications No. 2006-163451 filed on Jun. 13, 2006, the entire contents of which are incorporated herein by reference.

### BACKGROUND OF THE INVENTION

1. Field of the Invention

The present invention relates to a work assisting apparatus, method, and program.

2. Related Art

Taking measures against medical accidents is a critical issue and various safety measures have been proposed. JP-A 2001-312566 (Kokai) proposes a system that checks medical practice plans against actual medical practices to see whether there is any mistake in the medical practices. JP-A 2004-94363 (Kokai) proposes an apparatus that gives an advance notice or alert before and after a time at which a medical practice is performed. Some hospitals actually utilize barcodes to check nurses, patients, and/or medicines that are involved in a medical practice when a medical practice is to be performed. JP-A 2004-157614 (Kokai) describes a technique for outputting an alert by means of a sensor before an accident occurs.

However, JP-A 2001-312566 (Kokai) and JP-A 2004-94363 (Kokai) assume human input of information on medical practices and do not take into consideration utilization of sensor information. Thus, staff may not notice an error even if the error is included in input information, or may not input information that should be input for reasons such as being busy.

Although the technique of JP-A 2004-157614 (Kokai) employs sensor information, it attempts to detect a problem based on similarity between characteristics of behaviors that are seen when an accident occurs and sensor information. Consequently, the technique is technically, very difficult and has to await future technical advances to build a system with a small sensor, which does not hamper operations.

In addition, efforts so far made mainly focus on detection of errors and do not consider possible effects of errors. For example, an error of neglecting medication that causes no problem if neglected is not distinguished from neglect of medication that can leave serious aftereffects if neglected. As a result, it is possible that an important problem is difficult to be solved.

In addition, conventional checks are for confirming if a medical practice is correct at the time it is carried out and cannot check it at the stage of preparation.

### SUMMARY OF THE INVENTION

According to an aspect of the present invention, there is provided with a work assisting apparatus, comprising:

an information storage configured to store
a plurality of process maps that define constraint on order of carrying out tasks in a work process,
task check information that represent check items for the tasks in each process map, and
task time information that represent required times for the tasks in each process map;

an instruction storage configured to store execution instruction information that instructs execution of a work;

a process map detection unit configured to detect a process map that matches to a work indicated in the execution instruction information;

an information collection unit configured to collect check information that is necessary for checking check items associated with tasks in detected process map;

a process monitoring unit configured to check the check items to detect a task error; and

a notification control unit configured to notify information that represents content of detected task error.

According to an aspect of the present invention, there is provided with a work assisting method, comprising:

providing an information storage which stores
a plurality of process maps that define constraint on order of carrying out tasks in a work process,
task check information that represent check items for the tasks in each process map, and
task time information that represent required times for the tasks in each process map;

inputting execution instruction information that instructs execution of a work;

detecting a process map that matches to a work indicated in the execution instruction information;

collecting check information that is necessary for checking check items associated with tasks in detected process map;

checking the check items to detect a task error; and

notifying information that represents content of detected task error.

According to an aspect of the present invention, there is provided with a computer program for causing a computer to execute instructions to perform steps of:

accessing an information storage which stores
a plurality of process maps that define constraint on order of carrying out tasks in a work process,
task check information that represent check items for the tasks in each process map, and
task time information that represent required times for the tasks in each process map;

inputting execution instruction information that instructs execution of a work;

detecting a process map that matches to a work indicated in the execution instruction information;

collecting check information that is necessary for checking check items associated with tasks in detected process map;

checking the check items to detect a task error; and

notifying information that represents content of detected task error.

### BRIEF DESCRIPTION OF THE DRAWINGS

FIG. 1 shows the exemplary configuration of an embodiment of the work assisting apparatus of the invention;

FIG. 2 shows an example of instruction information;

FIG. 3 shows an example of a process map;

FIG. 4 shows an example of task information according to the embodiment of FIG. 1;

FIG. 5 shows an example of schedule constraint information according to the embodiment of FIG. 10;

FIG. 6 shows an example of task 1 execution information;

FIG. 7 shows schedule constraint information that is updated from FIG. 5;

FIG. 8 shows an example of task 7 execution information;

FIG. 9 shows an example of an action list;

FIG. 10 shows the exemplary configuration of another embodiment of the work assisting apparatus of the invention;

FIG. 11 shows an example of task information according to the embodiment of FIG. 10;

FIG. 12 shows an example of a list of check programs;

FIG. 13 shows an example of schedule constraint information according to the embodiment of FIG. 10;

FIG. 14 shows schedule constraint information updated from FIG. 13;

FIG. 15 shows an example of process risk value priority information;

FIG. 16 shows an example of task 7 execution information;

FIG. 17 shows schedule constraint information updated from FIG. 14;

FIG. 18 shows an example of position information for a nurse who carried out start of instillation;

FIG. 19 shows another example of position information for the nurse who carried out start of instillation;

FIG. 20 shows yet another example of position information for the nurse who carried out start of instillation;

FIG. 21 shows an example of position information for another nurse; and

FIG. 22 is a flowchart illustrating an embodiment of the method of the invention.

### DETAILED DESCRIPTION OF THE INVENTION

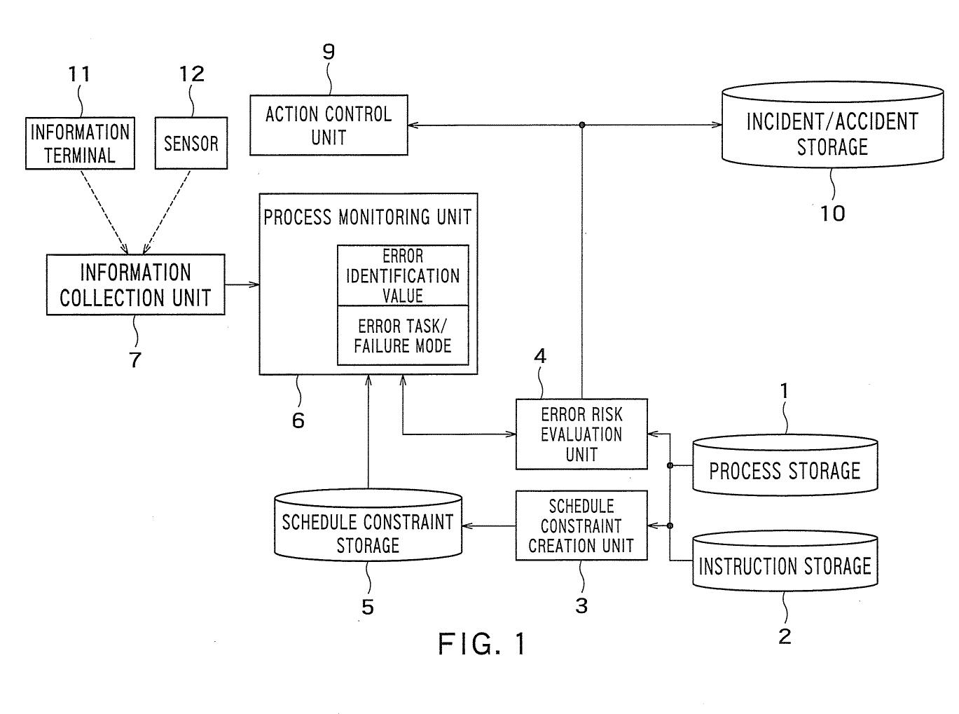

FIG. 1 is a block diagram showing the exemplary configuration of an embodiment of a work assisting apparatus (an incident/accident detection apparatus) of the present invention.

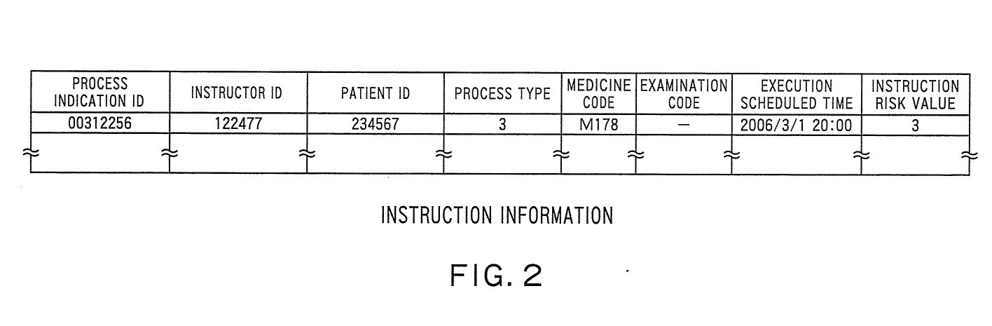

An instruction storage 2 accumulates instruction information (or execution instruction information) that indicates instructions for works given by an instructor (i.e., physician) such as shown in FIG. 2. Instruction information may be stored in the instruction storage 2, for example. A process type described in instruction information indicates a work process to be carried out. Assume that process type 3 is an instillation process. An execution scheduled time is a time at which execution is scheduled to be completed (i.e., execution completion scheduled time). However, the present invention can be also implemented with the execution scheduled time being a time at which execution is scheduled to start (i.e., execution start scheduled time). An instruction risk value is a risk value set by an instructor, which will be described in detail below.

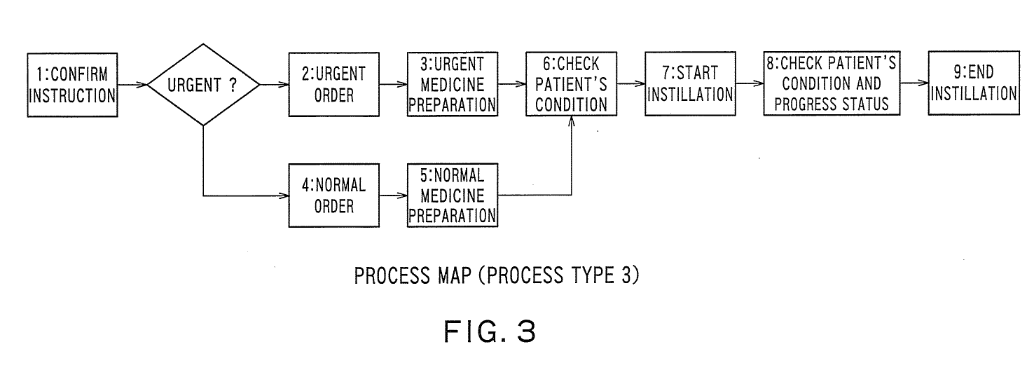

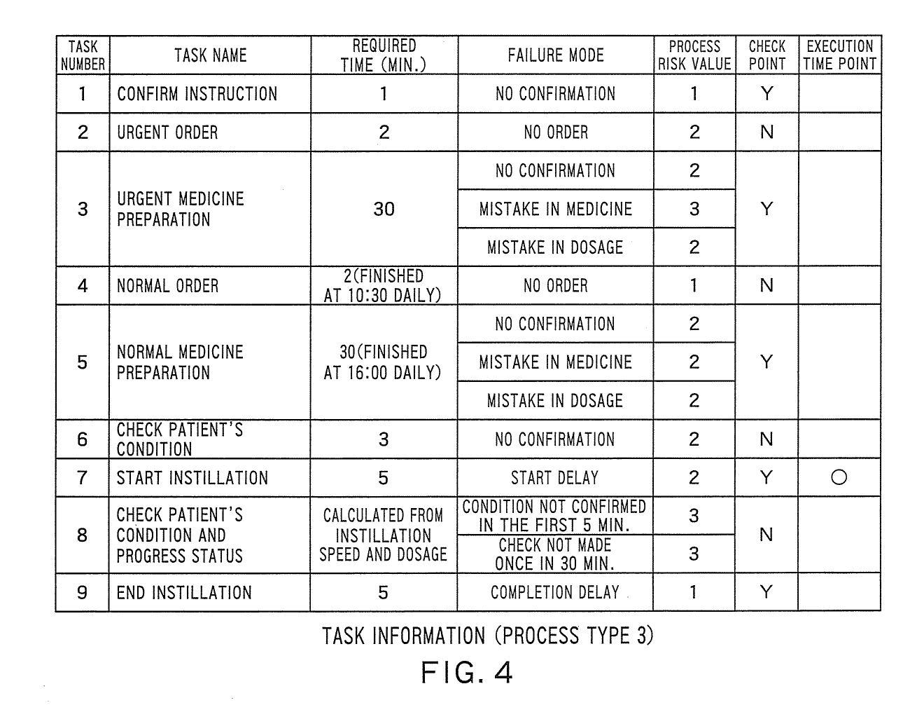

A process storage (or information storage) 1 stores process maps and task information. An example of a process map for process type 3 is shown in FIG. 3. An example of task information for process type 3 is shown in FIG. 4.

A process map defines constraint on order of carrying out tasks in a work process. In the process map shown in FIG. 3, there are an emergency path that passes through tasks 1, 2, 3, 6, 7, 8 and 9 and a normal path that passes through tasks 1, 4, 5, 6, 7, 8 and 9.

For each task in a process map, task information describes a task number, a task name, a required time, a failure mode, a process risk value, a check point, and an execution time point. Required time is an amount of time that is needed for executing a task. Data including a task number or task name and a required time for a task corresponds to task time information, for example. A failure mode represents a manner of failure that can occur in a task. In each task, each failure mode is checked in a manner described below. Process risk value, check point, and execution time point will be described below.

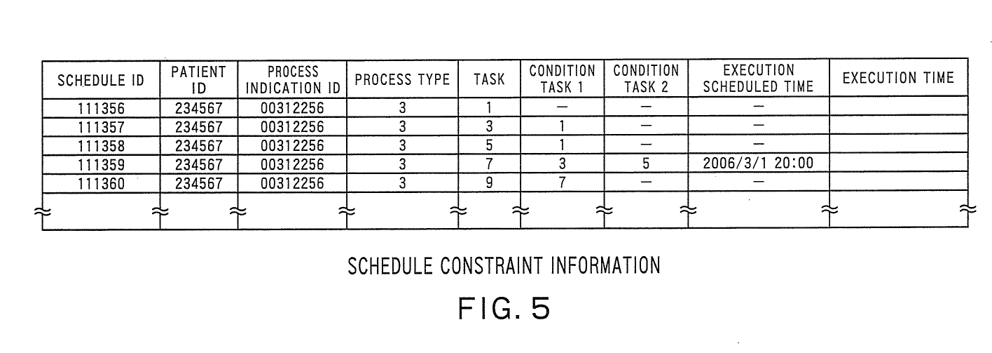

When instruction information is stored in the instruction storage 2, a schedule constraint creation unit 3 detects a process map and task information that correspond to the process type in the instruction information. Thus, the schedule constraint creation unit 3 includes a process map detection unit. The schedule constraint creation unit 3 creates schedule constraint information from the instruction information, process map and task information, and stores created schedule constraint information in the schedule constraint storage (or information storage) 5. FIG. 5 shows an example of schedule constraint information that is created from the instruction information of FIG. 2, the process map of FIG. 3 and the task information of FIG. 4. More specifically, schedule constraint information is created in the following manner.

Initially, in task information for process type 3 (see FIG. 4), “1: confirm instruction”, “3: urgent medicine preparation”, “5: normal medicine preparation”, “7: start instillation” and “9: end instillation” are specified as check points. A check point is indicated with letter “Y”. Letter “Y” corresponds to task specification information. A check point represents a task for which failure mode should be checked among tasks in a process map. Schedule constraint associated with a task having letter “Y” is registered in schedule constraint information as shown in FIG. 5. In schedule constraint information shown in FIG. 5, a condition task represents a task that should be carried out in advance. For example, in the process map of FIG. 3 (process type 3), it can be seen from the direction of arrows that “1: confirm instruction” should be carried out before “3: urgent medicine preparation”, and task 1 is registered as a condition task for task 3. For other tasks as well, tasks that should be carried out beforehand can be seen from a process map and tasks that should be carried out in advance are registered as condition tasks. In addition to failure modes being checked for a task with “Y” as mentioned above, it is also checked whether there is any error (or an incident/accident) in the order of carrying out tasks based on its condition tasks in schedule constraint information. Here, as “◯” is marked in “7: start instillation” in the column of execution time point in task information (see FIG. 4), the execution scheduled time described in the instruction information of FIG. 2 is registered as the execution scheduled time of “7: start instillation” in schedule constraint information (see FIG. 5). This “◯” in execution time point specifies a task for which it should be checked whether the task has been carried out by its execution scheduled time. It is noted that “7: start instillation” corresponds to a preparation process performed just prior to starting instillation (e.g., a process done up to inserting an injection needle to a patient).

Based on the schedule constraint information shown in FIG. 5, an example of a hospital operation (i.e., care) will be illustrated below.

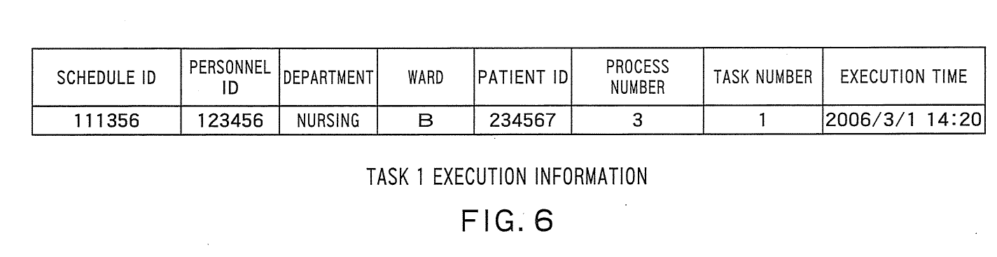

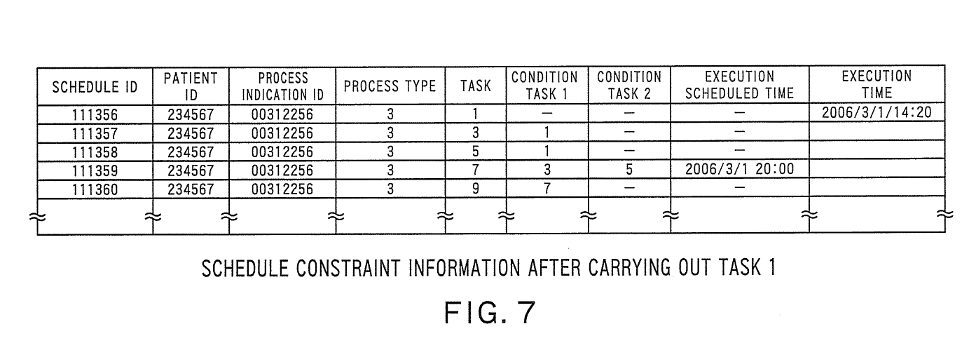

Assume that a nurse (whose personnel ID is 123456) carries out the task of “1: confirm instruction” at 14:20 and transmits task information indicating that he has done the task 1 (i.e., task 1 execution information) to the present apparatus using the information terminal 11. An example of task 1 execution information is shown in FIG. 6. Task execution information includes personnel ID, task number, process number, and execution time or the like. An execution time represents a time at which execution of task 1 is finished (i.e., execution completion time). However, the present invention can be also implemented with execution time being handled as a time to start execution (execution start time). The information terminal 11 may be a portable device such as a personal digital assistant (PDA) or a stationary device such as a personal computer. The task 1 execution information is received by an information collection unit 7 and passed to a process monitoring unit 6. Based on the task 1 execution information, the process monitoring unit 6 records the execution time in the schedule constraint information of FIG. 5 that is stored in schedule constraint storage 5. As a result, schedule constraint information is updated as shown in FIG. 7.

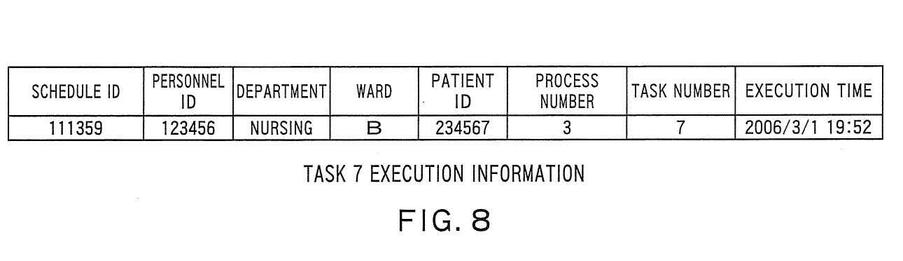

Assume that the nurse subsequently completes execution of task “7: start instillation” and transmits task 7 execution information shown in FIG. 8 to the information collection unit 7 using the information terminal 11. The task 7 execution information is passed from the information collection unit 7 to the process monitoring unit 6.

The process monitoring unit 6 confirms schedule constraint information (see FIG. 7) stored in the schedule constraint storage 5. In the row of task 7 (schedule ID: 111359), tasks 3 and 5 are specified as condition tasks. This means that task 3 or task 5 should be finished before task 7 is carried out. Confirming the execution times of tasks 3 and 5 in schedule constraint information, entries for both the tasks are empty, so that the process monitoring unit 6 determines that neither of task 3 nor 5 has been carried out yet. Thus, the process monitoring unit 6 passes an error identification value “1” which indicates presence of an error, error task information that indicates an error task 3 or 5, and failure mode information that indicates that the failure mode is “no confirmation” (see FIG. 4), to an error risk evaluation unit 4. The process monitoring unit 6 also passes a process indication ID (00312256) that is described in the schedule constraint information to the error risk evaluation unit 4.

The error risk evaluation unit 4 references task information for process 3 that is stored in the process storage 1 to obtain process risk values for the failure mode “no confirmation” (i.e., a first risk value) for tasks 3 and 5. The error risk evaluation unit 4 adopts the larger one of the process risk values for the two tasks. In this example, since process risk values for the tasks are “2”, “2” is adopted as process risk value.

The error risk evaluation unit 4 also obtains an instruction risk value (a second risk value) “3” from instruction information (see FIG. 2) that has a process indication ID ”00312256” stored in the instruction storage 2.

The error risk evaluation unit 4 adopts the smaller one of the process risk value and the instruction risk value as error risk value. Since the process risk value is “2” and the instruction risk value is “3”, “2” is adopted as error risk value. The error risk evaluation unit 4 passes the adopted error risk value to an action control unit (or communication control unit) 9. In this example, an error risk value “2” is passed to the action control unit 9. The error risk evaluation unit 4 also passes an error identification value, error task information, and failure mode information received from the process monitoring unit 6 to the action control unit 9.

Here, instruction risk value, process risk value and error risk value will be described. An instruction risk value indicates the maximum risk which the current instruction itself possibly has. For example, when the medicine is a vitamin, failure to give the medicine does not lead to a significant problem. Accordingly, even in the same process, the risk value for giving a vitamin is set to be small and that for giving an anticancer or narcotic drug is set to be large. A process risk value is a value representing the worst risk for a process that is assumed when an error occurs in a task described in task information. Since a process risk value is a risk value for the assumed worst case as just mentioned, it tends to be generally set at a large value regardless of kinds of medicines and so forth. However, a process risk value is advantageous in that it can be set for each task. Thus, this embodiment adopts an error risk value that takes into consideration both the instruction risk value and the process risk value as a final risk value.

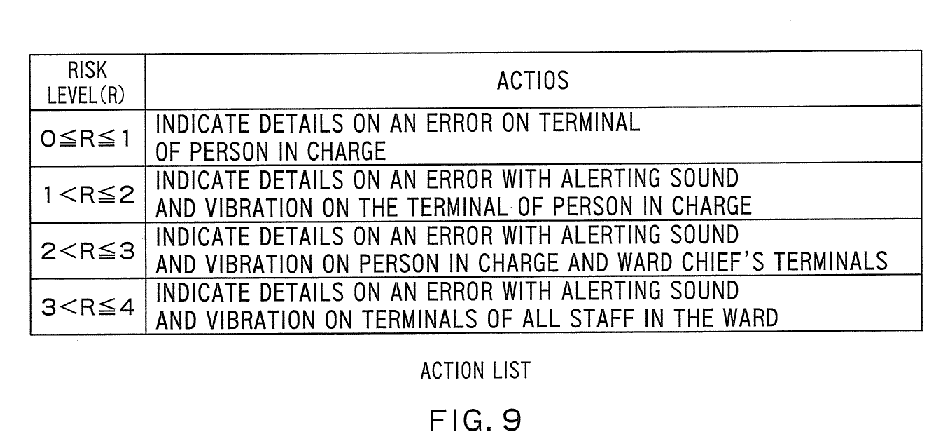

The action control unit 9 uses an error risk value passed from the error risk evaluation unit 4 as the risk level to notify details on an error by means of a notification scheme appropriate for the risk level in accordance with the action list shown in FIG. 9 (or performs notification control). The action list describes actions (or notification schemes) according to the risk level. The notification scheme may include information that indicates a device (terminal) to receive notification and how to show details on an error on the device (terminal), for example. A “person in charge” in the action list refers to a person who has the personnel ID described in task execution information (see FIG. 6).

The incident/accident storage 10 receives from the error risk evaluation unit 4 the error identification value, error task information and failure mode information that are obtained by the process monitoring unit 6 as well as an error risk value obtained by the error risk evaluation unit 4, and records them in an incident/accident database.

In this manner, while presence of an error in the order of carrying out tasks is checked based on schedule constraint information, each failure of task with letter “Y” is checked as mentioned above. For task 3, for example, it is checked whether confirmation has been made and whether there has been any mistake in medicine, and whether there has been any mistake in medicine dosage. Failure mode “no confirmation” is detected if confirmation has not been made, failure mode “mistake in medicine” is detected if there has been a mistake in medicine, and failure mode “mistake in dosage” is detected if there has been a mistake in medicine dosage. To check for failure mode, a nurse inputs task execution information (see FIG. 6) using the information terminal 11 immediately before or after he carries out the task. The kind and dosage of a medicine that will be used or was used is read from a barcode or two-dimensional code attached on the pouch of the medicine by the sensor 12, for example, and input as part of task execution information. Medicine is an example of articles that are handled in work. The sensor 12 may be incorporated into the information terminal 11.

A task with mark “◯” in the column of execution time point in task information is checked for whether the task has been finished by its execution scheduled time. In this example, in the schedule constraint information of FIG. 5, it is checked whether task 7 has been carried out by its execution schedule time. As he finishes task 7, the nurse inputs task 7 execution information. If task 7 execution information has not been received by the execution schedule time, it is determined that task 7 has not been finished by its execution scheduled time and failure mode “start delay” is detected.

In this embodiment, check items associated with a task are items that should be checked for occurrence of any incident/accident with respect to the task. For example, check items for task 7 are whether or not task 7 has been carried out by its execution scheduled time (i.e., whether there is delay in start) and whether task 3 or 5 has been carried out before task 7. Check items for task 3 are whether or not confirmation has been made, whether there is a mistake in medicine, whether there is a mistake in dosage, and whether task 1 has been carried out before task 3. For other tasks as well, check items can be identified in the same manner. It is possible to provide a check item of whether a task has taken more than its required time plus a margin time. Association of a task with check items corresponds to task check information. In this embodiment, task check information is included in task information (e.g., failure mode and “◯” in execution time point) and schedule constraint information (e.g., task conditions).

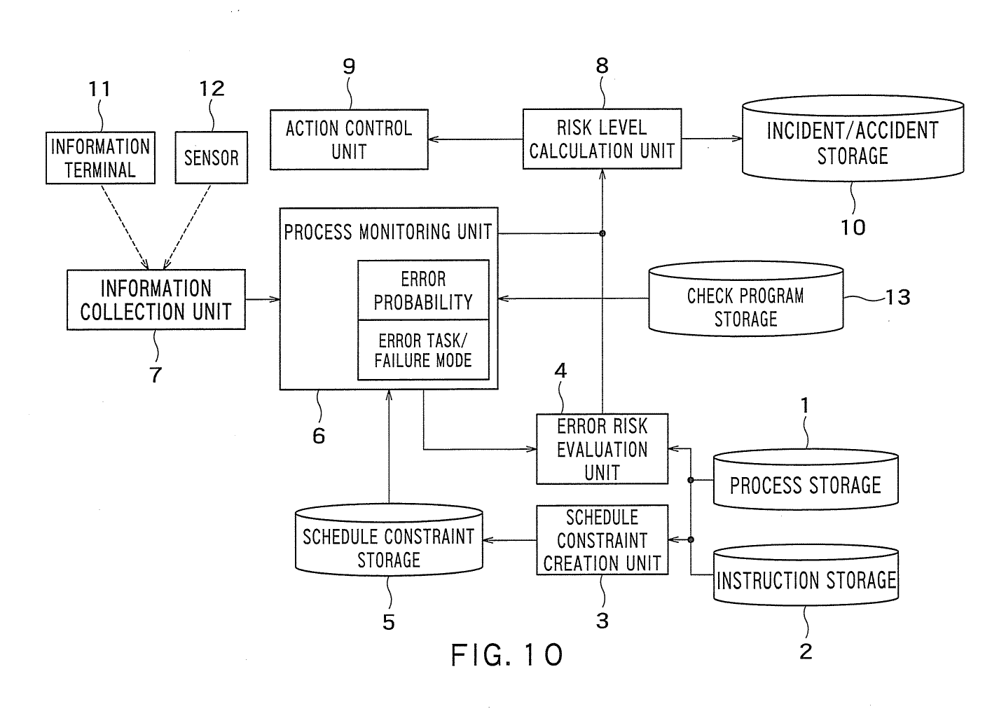

FIG. 10 is a block diagram showing the exemplary configuration of another embodiment of the work assisting apparatus of the invention. The same reference numerals are given to elements with the same names as in FIG. 1 and redundant description will be omitted except for extended processes.

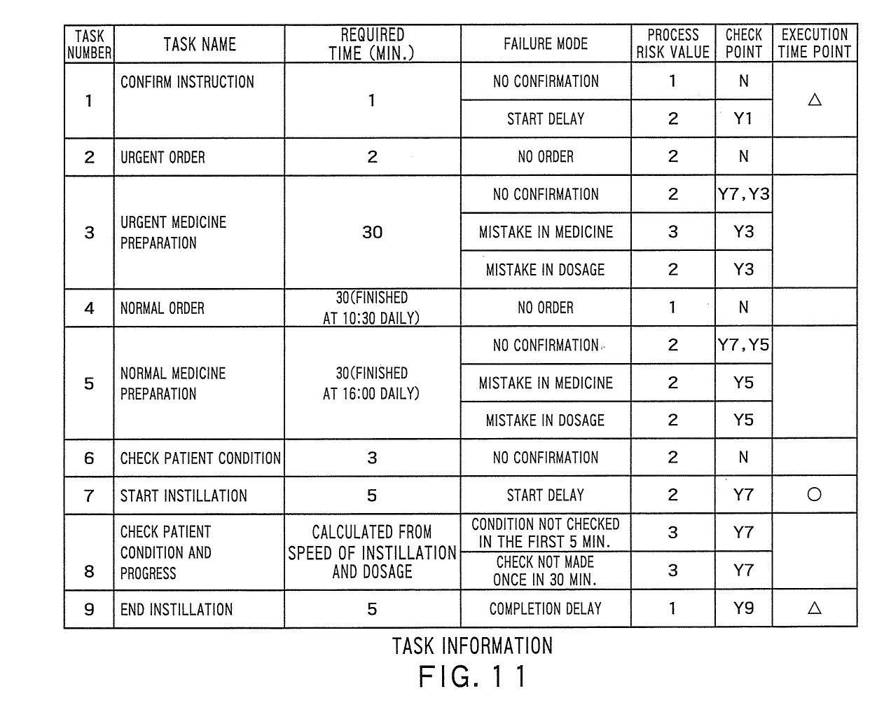

This embodiment employs the process map shown in FIG. 3, which was used in the embodiment described above, as a process map. This embodiment also uses task information shown in FIG. 11.

A check point field is prepared for each failure mode, and “Y*” (“*1” indicates a task number) is marked in the check point fields for failure modes in tasks 1, 3, 5, 7, 8 and 9. “Y*” means that a program associated with the failure mode indicated in the same row as Y* will be executed when task execution information for task “*” is input.

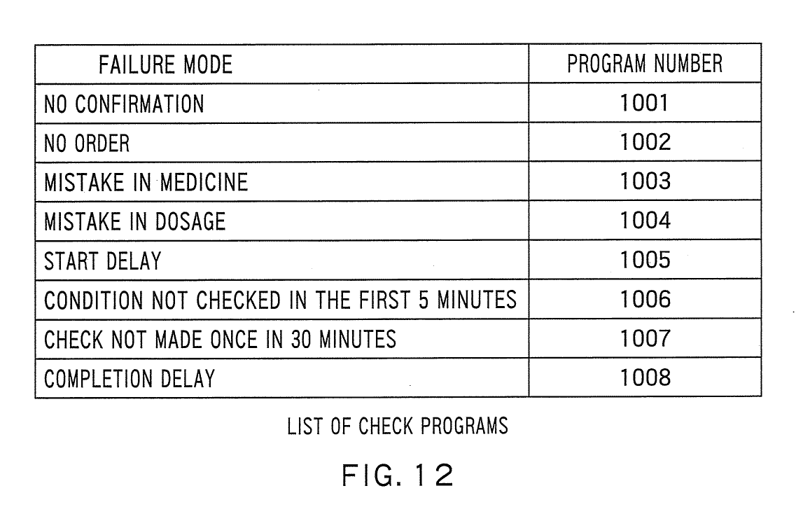

A program associated with each failure mode is stored in the check program storage 13. More specifically, a list of check programs that indicate program numbers for failure modes and programs corresponding to the program numbers are stored in the check program storage 13. An example of the list of check programs is shown in FIG. 12.

In the task information of FIG. 11, in addition to “◯” being marked in the execution time point for task 7 (i.e., start instillation) as in the above described embodiment, “Δ” is additionally marked in tasks 1 and 9. “Δ” and “◯” are the same in that they specify a task that should be checked for whether it has been carried out by its execution schedule time, except that, for “Δ”, the execution schedule time of the task is automatically generated and registered in schedule constraint information (for “◯”, an execution scheduled time described in instruction information is registered as it is). The execution scheduled time for a task with “Δ” is calculated using the required time of tasks. For example, the execution scheduled time for task 1 is determined by calculating when task 1 should be finished in order for the task 7 to finish as scheduled using required times of each task.

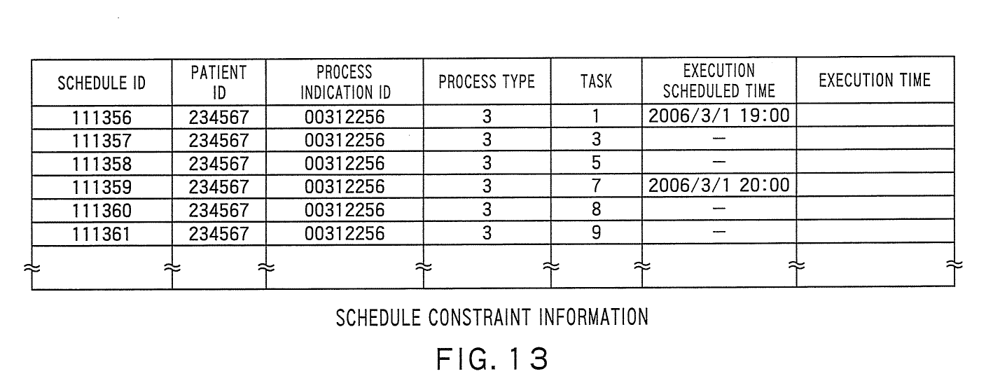

FIG. 13 illustrates schedule constraint information created from the instruction information of FIG. 2 and the task information of FIG. 11 by the schedule constraint creation unit 3.

Tasks 1, 3, 5, 7, 8 and 9 that have “Y*” in their check point fields are registered. The execution scheduled time for task 1 that has “Δ” is automatically generated and registered. Automated generation of execution scheduled time for task 9 is made at a point at which task 7 with “◯” is finished.

Describing more specifically, automated generation of execution scheduled time for task 1 (19:00) is made as follows.

In the process map of FIG. 2, if a work flow follows an emergency path, time required from completion of task 1 to completion of task 7 is 40 minutes (=2+30+3+5). Multiplying this by 1.5, which is a margin factor, 60 minutes is required. Consequently, the execution scheduled time for task 1 is 19:00, which is 60 minutes before that of task 7.

On the other hand, if the work flow follows a normal path, it can be seen from task information of FIG. 11 that task 4 needs to be finished at 10:30. Considering the required time of two minutes for task 4 plus the margin factor, task 1 needs to be finished three minutes before task 4. Consequently, the execution scheduled time for task 1 is determined to be 10:27.

Taking the later of the two times, the execution scheduled time of task 1 is registered as 19:00 as shown in FIG. 13.

The process monitoring unit 6 starts up monitoring programs for monitoring execution of tasks 1 and 7 for which execution scheduled times have been registered. If a value has not been described in the execution time field in schedule constraint information by the execution scheduled times (i.e., task execution information has not been received from a nurse), the process monitoring unit 6 calculates an error probability, which will be discussed below, to be 1.0 (or 100%) and identifies an error task and a failure mode. In this example, if task execution information is not input by the execution scheduled time with respect to task 1, the process monitoring unit 6 identifies error task 1 and failure mode of “start delay”. Or if task execution information is not input by the execution scheduled time with respect to task 7, the process monitoring unit 6 identifies error task 7 and failure mode of “start delay”.

The process monitoring unit 6 passes information indicating the calculated error probability, error task information indicating the identified error task, and failure mode information indicating the identified failure mode to the error risk evaluation unit 4.

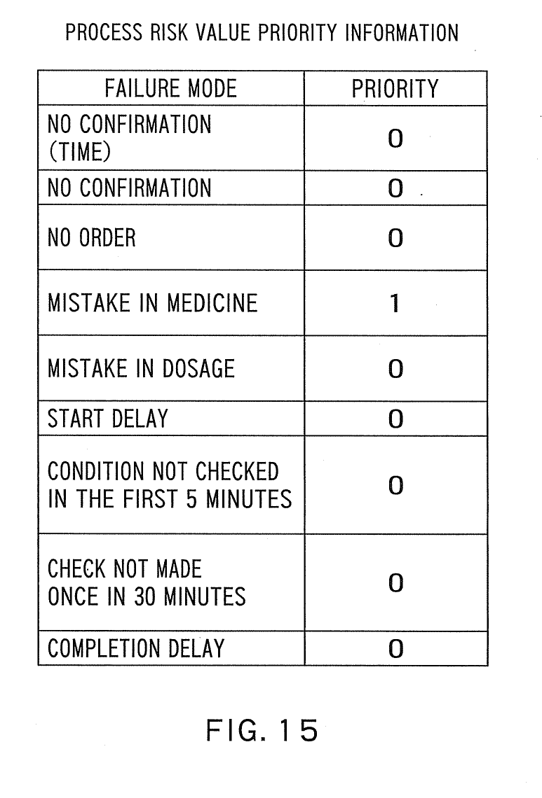

The error risk evaluation unit 4 determines an error risk value from the process risk value corresponding to the identified failure mode, the instruction risk value described in instruction information, and process risk value priority information shown in FIG. 15. In the process risk value priority information, either 0 or 1 is set as priority value for each failure mode. If the priority value for the identified failure mode is 0, the error risk evaluation unit 4 takes the smaller of the process risk value and the instruction risk value as the error risk value. If the priority value is 1, the error risk evaluation unit 4 takes the process risk value as the error risk value.

The error risk evaluation unit 4 passes information indicating the determined error risk value, information indicating the error probability, error task information, and failure mode information to a risk level calculation unit 8.

The risk level calculation unit 8 calculates a risk level based on the error risk value and error probability received from the error risk evaluation unit 4. Here, since one error risk value and one error probability are input, the risk level calculation unit 8 calculates the risk level by multiplying them (i.e., error risk value×1.0). The risk level calculation unit 8 passes the calculated risk level, error task information, and failure mode information to the action control unit 9.

The action control unit 9 controls the information terminal 11 in accordance with the action list in FIG. 9 based on the risk level calculated by the risk level calculation unit 8 in the same manner as in the above described embodiment.

The incident/accident storage 10 records the risk level, the error task, the failure mode, and the error probability to the incident/accident database.

The following description will show other examples of operations after generation of schedule constraint information shown in FIG. 13 in this embodiment.

At 14:20, a nurse (personnel ID: 123456) finishes task 1 and transmits task 1 execution information shown in FIG. 6 to the present apparatus using the information terminal 11. The task 1 execution information is received by the information collection unit 7 and passed to the process monitoring unit 6.

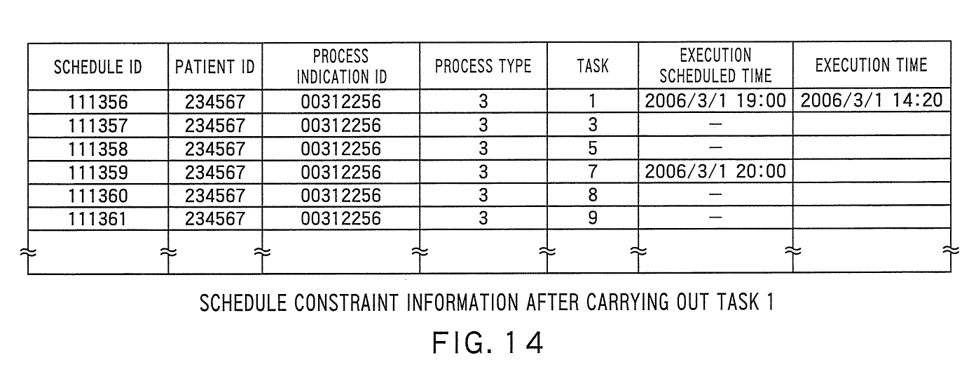

Based on the task 1 execution information, the process monitoring unit 6 records the execution time in schedule constraint information of FIG. 13 stored in the schedule constraint storage (or information storage) 5, and consequently, schedule constraint information is updated as shown FIG. 14. At this time, the process monitoring unit 6 references task information (see FIG. 11) to find that “Y1” is marked in the check point for failure mode “start delay” for task 1, so that it references the check program storage 13. The check program storage 13 starts up a program 1005 that is associated with failure mode “start delay”. In this example, the program 1005 stops a monitoring program that has been started up for task 1.

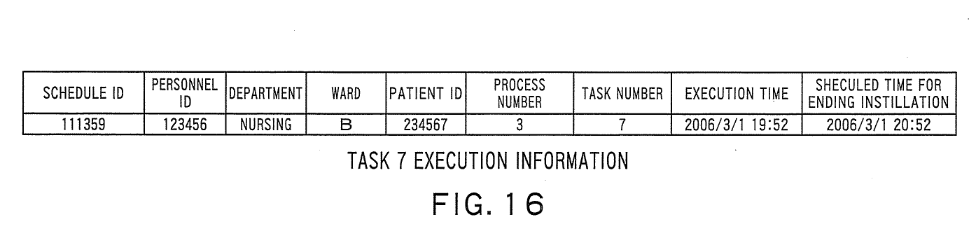

Assume that the nurse subsequently finishes task 7 (start instillation) and transmits task 7 execution information shown in FIG. 16 to the information collection unit 7 using the information terminal 11. The task 7 execution information is passed from the information collection unit 7 to the process monitoring unit 6.

The process monitoring unit 6 references task information of FIG. 11 and confirms the check point field for failure mode “start delay” of task 7 to find “Y7” is marked in it.

Tracing the process map (see FIG. 3) from the task 7 in the direction reverse to the arrows, there are two paths:

a first path that passes through task 6←task 3←task 2←task 1, and

a second path that passes through task 6←task 5←task 4←task 1

In each of the paths, one failure mode with “Y7” marked in the check point field is found. That is, they are “no confirmation” for task 3 and “no confirmation” for task 5.

Tracing the process map from task 7 in the forward direction indicated by the arrows, the path is task 8→task 9. On this path, “Y7” is marked in check point fields for “condition not checked in the first five minutes” and “check not made once in 30 minutes” for task 8.

The process monitoring unit 6 then references the list of check programs stored in the check program storage 13 and starts up a necessary program. That is, it starts up the program 1005 for the failure mode “start delay” for task 7. The process monitoring unit 6 also starts up a program 1001 for failure mode “no confirmation” for tasks 3 and 5. The program 1001 confirms whether the task associated with it have been carried out or not. The process monitoring unit 6 also starts up a program 1006 and a program 1007 in accordance with the two failure modes for task 8, i.e., “condition not checked in the first five minutes” and “check not made once in 30 minutes”.

In the present example, it is detected by the program 1001, which is started up for tasks 3 and 5, that neither of task 3 nor task 5 has been carried out yet before task 7 is carried out. That is, an error of failure mode “no confirmation” is detected for tasks 3 and 5. That is, it is detected that both the first and second paths are not in progress appropriately. Consequently, as information indicating an error probability, error task information and failure mode information, the process monitoring unit 6 generates

error probability 0.5, error task 3, “no confirmation”; and

error probability 0.5, error task 5, “no confirmation”.

Process risk values for failure mode “no confirmation” for tasks 3 and 5 are both “2” (see FIG. 11) and these process values are passed from the process monitoring unit 6 to the error risk evaluation unit 4.

The error risk evaluation unit 4 obtains an error risk value “3” by referencing instruction information stored in the instruction storage 2 (see FIG. 2). The error risk evaluation unit 4 references process risk value priority information based on failure mode “no confirmation” for tasks 3 and 5. Since the priority value for “no confirmation” is 0, the error risk evaluation unit 4 adopts “2”, the smaller of the process risk values “2” and the instruction risk value “3”, as the error risk value for the tasks 3 and 5.

The error risk evaluation unit 4 passes to the risk level calculation unit 8

error probability “0.5”, error task 3, error risk value “2”, and

error probability “0.5”, error task 5, error risk value “2”.

The error risk evaluation 4 may further pass failure mode information for each of the tasks to the risk level calculation unit 8.

The risk level calculation unit 8 calculates the risk level based on the values input from the error risk evaluation unit 4. In this example, assuming that the expected value of error risk values represents the risk level, the risk level will be (0.5×2)+(0.5×2)=2

Based on the risk level “2” calculated by the risk level calculation unit 8, the action control unit 9 controls the information terminal 11 in accordance with the action list shown in FIG. 9.

The incident/accident storage 10 records the risk level, error task, error probability, and failure mode to the incident/accident database.

Assume that the action control unit 9 alerts the nurse's information terminal 11 and the nurse cancels task 7 execution information of FIG. 16 that he previously inputted. At this time, started up programs 1005, 1006 and 1007 are terminated (assume that the program 1001 has been terminated after confirmation of whether tasks 3 and 5 were carried out or not). Then, the nurse takes necessary actions (here, assume that he performs “2: urgent ordering” and “3: urgent medicine preparation”, and “6: check patient's condition”), finishes task 7 (i.e., instillation start) and inputs task 7 execution information again. For the sake of brevity, assume that the nurse inputs task execution information of FIG. 16 which is the same as in the earlier description. At this point, as in the earlier example, the program 1005 is started up for failure mode “start delay” for task 7 and the program 1001 for failure modes “no confirmation” for tasks 3 and 5. Further, the programs 1006 and 1007 are started up for the two failure modes “condition not checked in the first five minutes” and “check not made once in 30 minutes” for task 8, respectively.

In this case, since task 3 is carried out before task 7 is carried out (task 3 execution information is input by the nurse and its execution time is recorded in schedule constraint information) and task 7 execution information is input before its execution scheduled time, no error is detected. The program 1005 which has been started up for the failure mode “start delay” for task 7 is terminated after the monitoring program for task 7 is stopped. The program 1001 is terminated when it is confirmed whether or not tasks 3 and 5 have been carried out. However, the programs 1006 and 1007 remain started up after task 7 is carried out (i.e., after task 7 execution information is input) for checking the failure mode for task 8. The programs 1006 and 1007 may be started up immediately after task 7 is finished.

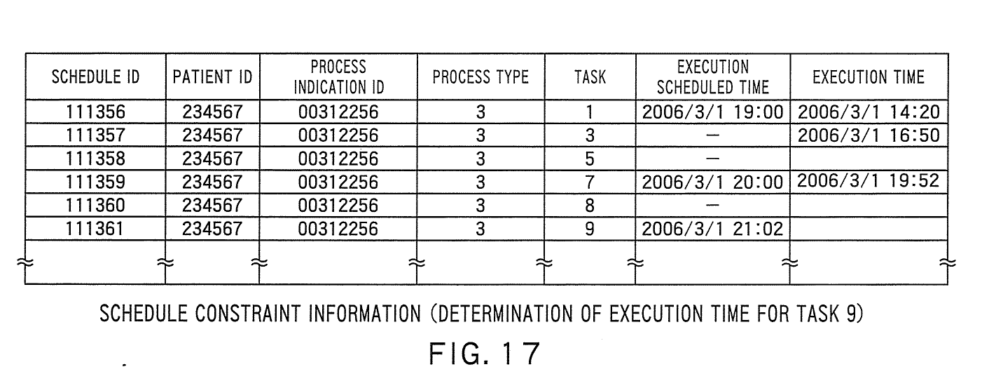

The task 7 execution information input from the information terminal 11 is passed to the process monitoring unit 6 via the information collection unit 7. The task 7 execution information shows that the execution termination scheduled time for task 9 which has “Δ” in execution time point is 20:52 (see FIG. 16). The process monitoring unit 6 adds a margin time of 10 minutes and registers an execution scheduled time “21:01” for task 9 in schedule constraint information. Schedule constraint information at this point is shown in FIG. 17. The process monitoring unit 6 starts up a monitoring program for monitoring the execution scheduled time of task 9.

After task 7 is finished, the programs 1006 and 1007 check whether task 8 is being appropriately executed using information from the sensor 12. That is, they check failure modes “condition not checked in the first five minutes” and “check not made once in 30 minutes”. The sensor 12 may be an RFID reader, barcode reader, or two-dimensional code reader, and may include a video camera and so forth. Examples of checking by the program 1006 will be shown below in several cases.

### (Case 1: When there is n Error)

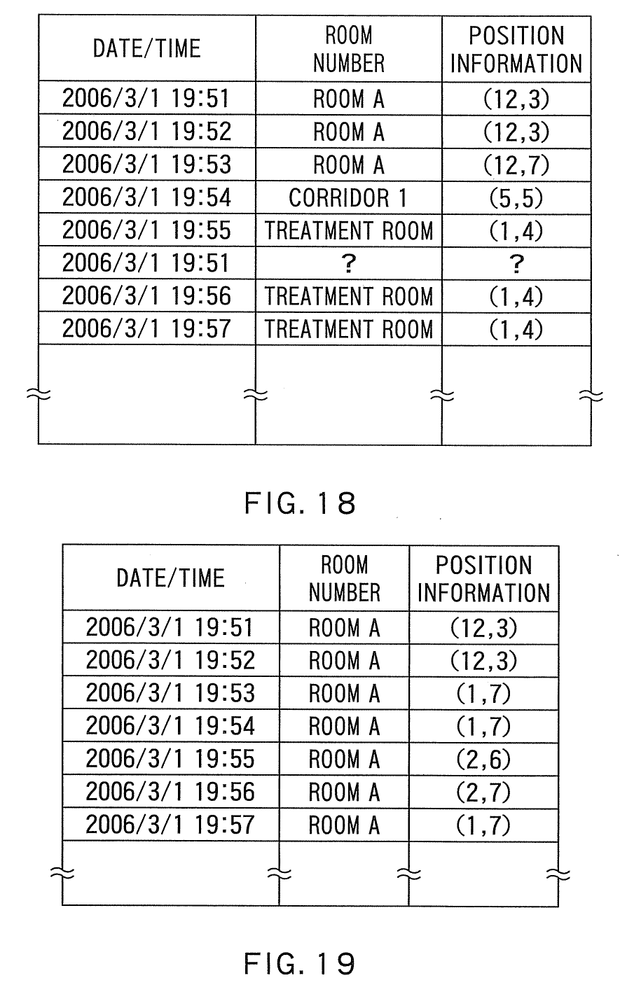

FIG. 18 shows an example of position information for a nurse (personnel ID: 123456) that has carried out start of instillation (task 7). An RFID tag is embedded in a device such as the information terminal 11 or an ID card carried by the nurse so that position information for the nurse is obtained by scanning the RFID tag with the sensor 12.

Although it is seen from the schedule constraint information of FIG. 17 that task 7 was finished at 19:52, the position information of FIG. 18 shows that the nurse was in room A at 19:52 but was out in the corridor at 19:54 and subsequently went to a treatment room. From this, the program 1006 recognizes that an error of failure mode “condition not checked in the first five minutes” is probably occurring and returns error probability of 1.0. Thus, the process monitoring unit 6 outputs error probability of 1.0, error task 8, and failure mode “condition not checked in the first five minutes”.

### (Case 2: When there is a Possible Error)

FIG. 19 shows another example of position information for the nurse (personnel ID: 123456) who carried out start of instillation.

The information shows that the nurse stays in room A after finishing start of instillation but is acting at a position significantly off the position where he finished start of instillation (12, 3). The program 1006 decides that it cannot determine with the precision of the sensor 12 whether the nurse is doing another job while sometimes watching the patient's condition or does not watch the patient's condition at all, and returns an error probability of 0.5. Accordingly, the process monitoring unit 6 outputs an error probability of 0.5, error task 8, and failure mode “condition not checked in the first five minutes”.

### (Case 3: When there is No Error)

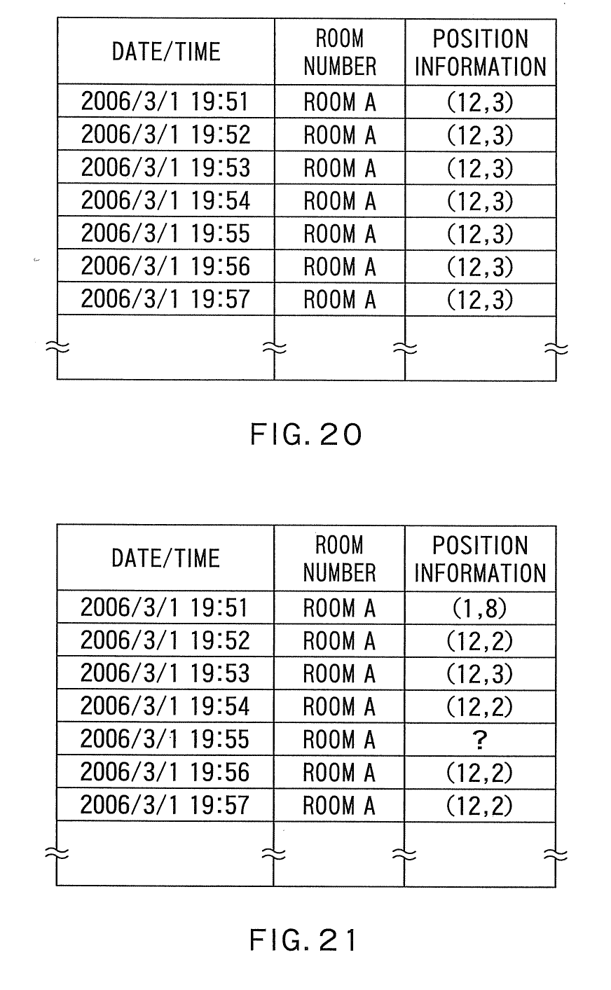

FIG. 20 shows yet another example of position information for the nurse (personnel ID: 123456) who carried out start of instillation.

Since the nurse stays at the same position for more than five minutes after finishing start of instillation, the nurse can be estimated to be watching the patient's condition without any problem. Thus, the program 1006 returns an error probability of 0. Accordingly, the process monitoring unit 6 outputs an error probability of 0, error task 8 and failure mode “condition not checked in the first five minutes”.

### (Case 4: When Another Nurse is Also Considered)

The cases 1 to 3 described above assume that a nurse who carries out start of instillation is to watch the patient's condition himself. However, if another nurse is allowed to instead observe the patient's condition, it is required to confirm position information also for nurses other than the nurse (personnel ID: 123456). An example of position information for another nurse is shown in FIG. 21.

It can be seen from the information that the nurse 123456 who finished start of instillation is not beside the patient who is now getting instillation but another nurse is attending the patient. Accordingly, the program 1006 determines that there is no particular problem and returns an error probability of 0.1. Thus, the process monitoring unit 6 outputs an error probability of 0.1, error task 8, and failure mode “condition not checked in the first five minutes”.

Examples of check items in this embodiment will be shown below. For example, check items for task 7 are whether task 3 or 5 has been carried out before task 7 is carried out and whether the task is finished by its execution scheduled time (i.e., whether delay in start has occurred or not). Check items for task 3 are whether confirmation has been made, whether there is a mistake in medicine, whether there is a mistake in dosage, and whether task 1 has been carried out before task 3. Check items for task 1 are whether the task is finished by its execution scheduled time (i.e., whether there is delay in start or not) and whether confirmation is made or not. Check items can be identified in the same manner for other tasks as well. Association of a task with check items corresponds to task check information. In this embodiment, task check information is included in task information and schedule constraint information.

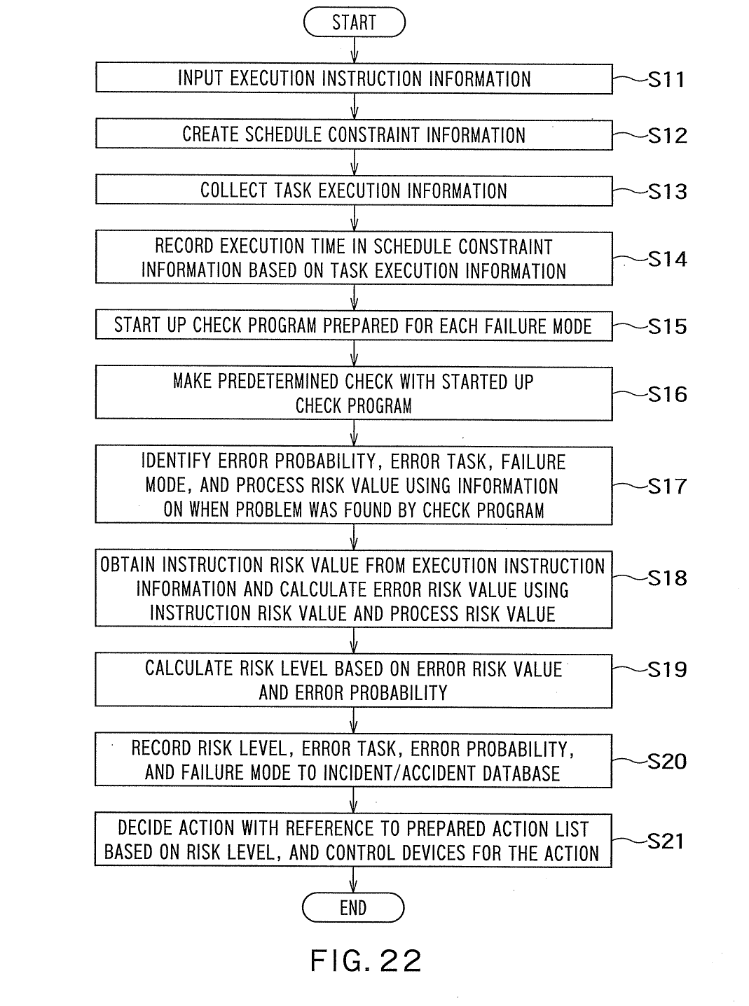

FIG. 22 is a flowchart showing an embodiment of the work assisting method of the present invention. A program that describes instructions for executing steps shown in the flowchart may be executed by a computer. The program may be stored in a computer-readable recording medium.

An execution instruction information that represents an instruction to execute a work is input from an instruction input unit (not shown) (S11).

Each time an instruction to execute a work is input, the schedule constraint creation unit 3 creates schedule constraint information (S12).

Every time a task is carried out, a staff member transmits task execution information and the information collection unit 7 collects the task execution information (S13).

The process monitoring unit 6 records the time at which the task was carried out in schedule constraint information based on task execution information collected by the information collection unit 7 (S14).

The process monitoring unit 6 references the check program storage 13 based on task information and starts up a check program prepared for each failure mode (S15).

The check program started up carries out predetermined check, and terminates if there is no problem or proceeds to the next step if there is a problem (S16).

The process monitoring unit 6 uses information provided by the check program when the problem was found to determine an error probability, an error task, a failure mode and a process risk value (S17).

The error risk evaluation unit 4 references execution instruction information to obtain an instruction risk value, and then uses the instruction risk value and the process risk value to calculate an error risk value (S18).

The risk level calculation unit 8 calculates the risk level based on the error risk value and error probability (S19).

The incident/accident storage 10 records the risk level, error task, error probability and failure mode in the incident/accident database (S20).

The action control unit 9 decides an action to be taken with reference to the prepared action list based on the risk level and controls devices for the action (S21).

As has been described, according to the embodiments of the invention, it is possible to check tasks in a work process from preparation of a medical practice to its execution and to give an alert at an early stage if a problem has occurred or even before a problem occurs so that solution of the problem can be facilitated. Further, degree of effect exerted by an error can be evaluated based on a process risk value, an instruction risk value and so on and intensive measures can be taken for a problem that can have significant effect. In addition, sensor information can be utilized with ease.

What is claimed is:

1. A work assisting apparatus, comprising:
an information storage configured to store
a plurality of process maps that define constraint on order of carrying out tasks in a work process,
task check information that represent check items for the tasks in each process map, and
task time information that represent required times for the tasks in each process map;
an instruction storage configured to store execution instruction information that instructs execution of a work;
a process map detection unit configured to detect a process map that matches to a work indicated in the execution instruction information;
an information collection unit configured to collect check information that is necessary for checking check items associated with tasks in detected process map;
a process monitoring unit configured to check the check items to detect a task error; and
a notification control unit configured to notify information that represents content of detected task error.

2. The apparatus according to claim 1, wherein the process monitoring unit checks the check item only for a task that is indicated in task specification information that specifies a task whose check item should be checked.

3. The apparatus according to claim 1, wherein
the information collection unit collects information on articles that are handled in the work.

4. The apparatus according to claim 1, wherein
the information collection unit collects position information that represents working positions of a person in charge of the work.

5. The apparatus according to claim 1, wherein
a check item associated with the task is concerning whether a second task that should be started or finished before the task, has been started or finished, and
the information collection unit collects task execution information that indicates that the second task and the task has been started or finished, and
the process monitoring unit detects the task error when the task has been started or finished before the second task is started or finished.

6. The apparatus according to claim 1, further comprising a schedule creation unit configured to create an execution schedule that represents times at which each task should be started or finished in the detected process map,
wherein the check item is concerning whether the task has been started or finished by its scheduled time,
the information collection unit collects task execution information that indicates that the task has been started or finished, and
the process monitoring unit detects the task error when the task has not been started or finished by its scheduled time.

7. The apparatus according to claim 6, wherein
the execution instruction information includes a scheduled time of starting or finishing a predetermined task, and
the schedule creation unit calculates scheduled times of starting or finishing for tasks others than the predetermined task by using the scheduled time of starting or finishing the predetermined task and the task time information.

8. The apparatus according to claim 1, wherein
a first risk value is assigned to each of the check items, and
the notification control unit decides a notification scheme for notifying information that represents content of the task error based on the first risk value assigned to the check item for which the task error is detected, and notifies the information that represents content of the task error according to decided notification scheme.

9. The apparatus according to claim 8, wherein
a second risk value is described in the execution instruction information, and
the notification control unit decides the notification scheme based on the first and second risk values.

10. The apparatus according to claim 8, wherein the notification control unit decides a device to receive notification and how the information that represents content of the task error is notified to the device, as the notification scheme.

11. The apparatus according to claim 1, wherein
a first risk value is assigned to each of the check items,
the process monitoring unit calculates an error probability which is a probability at which an task error detected for the check item the task is correct, and
the notification control unit calculates risk level from the first risk value assigned to the check item and the error probability, decides a notification scheme for notifying information that represents content of the task error based on calculated risk level, and notifies the information that represents content of the task error according to decided notification scheme.

12. The apparatus according to claim 11, wherein
a second risk value is described in the execution instruction information, and
the notification control unit calculates the risk level from the first risk value, the second risk value, and the error probability.

13. The apparatus according to claim 12, wherein
the notification control unit decides a device to receive notification and how the information that represents content of the task error is to be indicated on the device, as the notification scheme.

14. A work assisting method, comprising:
providing an information storage which stores
a plurality of process maps that define constraint on order of carrying out tasks in a work process,
task check information that represent check items for the tasks in each process map, and
task time information that represent required times for the tasks in each process map;
inputting execution instruction information that instructs execution of a work;
detecting a process map that matches to a work indicated in the execution instruction information;
collecting check information that is necessary for checking check items associated with tasks in detected process map;
checking the check items to detect a task error; and
notifying information that represents content of detected task error.

15. A computer program for causing a computer to execute instructions to perform steps of:
accessing an information storage which stores
a plurality of process maps that define constraint on order of carrying out tasks in a work process,
task check information that represent check items for the tasks in each process map, and
task time information that represent required times for the tasks in each process map;
inputting execution instruction information that instructs execution of a work;
detecting a process map that matches to a work indicated in the execution instruction information;
collecting check information that is necessary for checking check items associated with tasks in detected process map;
checking the check items to detect a task error; and
notifying information that represents content of detected task error
